(19) United States
(12) Patent Application Publication
(10) Pub. No.: US 2010/0189322 A1
(43) Pub. Date: Jul. 29, 2010

(54) DIAGNOSTIC SUPPORTING APPARATUS AND METHOD FOR CONTROLLING THE SAME

(75) Inventor: Yukio Sakagawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/692,851

(22) Filed: Jan. 25, 2010

(30) Foreign Application Priority Data
Jan. 27, 2009 (JP) 2009-015768

(51) Int. Cl. G06K 9/00

(52) U.S. Cl. 382/128

(57) ABSTRACT

In a diagnostic supporting apparatus, a CPU inputs medical inspection data relating to a schema background image, and analyzes a user's operation performed on the medical inspection data. Then, the CPU performs processing for selecting a schema background image to be displayed from a plurality of schema background images stored in a storage unit, based on an analysis result of the operation performed on the medical inspection data.

### BACKGROUND OF THE INVENTION

1. Field of the Invention

The present invention relates to a diagnostic supporting apparatus that includes a storage unit capable of storing a plurality of schema background images and can support a diagnosis to be performed based on at least one of the schema background images. The present invention relates to a method for controlling the diagnostic supporting apparatus.

The present invention further relates to a program that causes a computer to execute the control method, and a computer-readable storage medium that stores the program. More specifically, the present invention is applicable to a diagnostic supporting apparatus that generates medical documents, such as clinical records (diagnostic records) and image diagnosis reports.

2. Description of the Related Art

Physicians used to work with handwritten paper medical documents before introducing a system for generating electronic data of medical documents (e.g., clinical records and image diagnosis reports). Therefore, the physicians are forced to draw, by handwriting, a schema background image, more specifically, an illustration indicating a positional relationship between a human body structure and a diseased portion.

Medical information systems that were recently developed, such as a hospital information system (HIS) and a picture archiving communication system (PACS), could advance conversion of medical documents into electronic data. More specifically, a diagnostic supporting apparatus has been introduced to enable physicians to electronically generate and display medical documents (i.e., the clinical records and image diagnosis reports), which were conventionally generated by handwriting, using an information device. Further, the diagnostic supporting apparatus can communicate with other medical information systems.

When a medical document is electronically generated, physicians can relatively easily input character strings, for example, via a keyboard. Further, to draw a shape of an arbitrary portion or region of a patient, physicians can manipulate an input device (e.g., a mouse or a stylus). A locus drawn with the input device can be input as line drawing information. However, a human body structure to be included in a schema background image has a complicated shape. Therefore, the above-described drawing method using the mouse or the tablet is not useful to simplify the drawing operation to be performed by the physicians.

According to a conventional technique discussed in Japanese Patent Application Laid-Open No. 63-240832, image processing can be performed on a chest X-ray image to obtain a contour line of a lung field portion. The obtained contour line can be used to simplify the operation for generating a schema background image.

Further, according to a conventional technique discussed in Japanese Patent Application Laid-Open No. 2006-318154, numerous templates of schema background images (hereinafter, referred to as “basic schema background image”) are stored beforehand in an apparatus to enable physicians to select an appropriate basic schema background image. According to this technique, after a basic schema background image is selected, physicians can easily generate a desired schema background image by adding a simple illustration that indicates a diseased portion on the selected basic schema background image.

Further, according to a conventional technique discussed in Japanese Patent Application Laid-Open No. 11-312202, various schema background images are stored beforehand in an apparatus to enable physicians to input a name of a human body region to display a schema background image corresponding to the input region name. According to this technique, physicians can easily attach a desired schema background image to a medical document without performing an operation for selecting an appropriate one from numerous schema background images.

Further, as a technique relating to the present invention, the Digital Imaging and Communications in Medicine (DICOM) standard is known as a representative standardized communication protocol dedicated to medical image data. The DICOM standard allows a plurality of image diagnosis apparatuses, medical information servers, and medical information viewers to communicate with each other, even if they are manufactured by different manufactures.

The DICOM standard finely determines contents and data structures of medical information (e.g., image information and patient information), sequences in medical information communications, i.e., sequences for requiring services relating to the storage, fetch, print, and inquiry of images, and interfaces. The DICOM standard can be regarded as an international standard in the present medical image field. For example, a technique discussed in the following Japanese Patent Application Laid-Open No. 2000-287013 relates to an image communication method and a relevant apparatus that are conformable to the DICOM standard.

Further, as a technique relating to the present invention, a research and development is conventionally performed for segmentation and recognition of internal organs captured in medical images. The medical images include various types of images, such as simple X-ray images (roentgen images), X-ray Computed Tomography (CT) images, Magnetic Resonance Imaging (MRI) images. The medical images further include, as another types of images, Positron Emission Tomography (PET) images, Single Photon Emission Computed Tomography (SPECT) images, and ultrasonic images.

Moreover, as a technique relating to the present invention, a technique discussed in the following U.S. Pat. No. 5,668,888 detects anatomical features (e.g., a costal boundary) from a chest X-ray image. More specifically, the technique discussed in the U.S. Pat. No. 5,668,888 includes detecting fragments of the costal boundary based on the edge intensity and direction, connecting the detected fragments to form an elliptic (arc) curve, and extracting a circle by performing Hough conversion on edges other than the costal boundary.

However, according to the technique discussed in Japanese Patent Application Laid-Open No. 63-240832, a contour line of an unnecessary region other than the target region may be drawn in the operation for calculating contour lines of an image. Further, if the image contains noise, a contour of the target region may be partly lost or excessively added.

Further, according to the technique discussed in Japanese Patent Application Laid-Open No. 2006-318154, a user can easily select a suitable schema background image in a state where the numerous schema background images are stored hierarchically. However, according to the technique discussed in Japanese Patent Application Laid-Open No. 2006-318154, if a large number of schema background images are stored, physicians are forced to perform a complicated operation to select the suitable schema background image.

Further, according to the technique discussed in Japanese Patent Application Laid-Open No. 11-312202, physicians are required to precisely and correctly input the name of each region although they are not required to perform the operation for selecting an appropriate schema background image.

In short, according to the above-described conventional techniques, when a medical document is generated, it is difficult to effectively select a suitable schema background image from a plurality of schema background images.

### SUMMARY OF THE INVENTION

Exemplary embodiments of the present invention are directed to a technique capable of effectively selecting a suitable schema background image from a plurality of schema background images when a medical document is generated.

According to an aspect of the present invention, a diagnostic supporting apparatus includes a storage unit configured to store a plurality of schema background images and can support a diagnosis to be performed based on at least one of the schema background images. The diagnostic supporting apparatus includes an input unit configured to input medical inspection data of an inspection object; an analysis unit configured to analyze an operation performed on the medical inspection data; and a selection unit configured to select a schema background image, from the plurality of schema background images stored in the storage unit, based on an analysis result obtained by the analysis unit.

According to another aspect of the present invention, a method for controlling a diagnostic supporting apparatus that includes a storage unit configured to store a plurality of schema background images and can support a diagnosis to be performed based on at least one of the schema background images, includes inputting medical inspection data of an inspection object; analyzing an operation performed on the medical inspection data; and selecting a schema background image, from the plurality of schema background images stored in the storage unit, based on an obtained analysis result.

Further features and aspects of the present invention will become apparent from the following detailed description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view schematically illustrating an example of an overall configuration of a diagnostic support system according to a first exemplary embodiment of the present invention.

FIG. 2 is a flowchart illustrating an example of a processing procedure of a method for controlling the diagnostic supporting apparatus according to the first exemplary embodiment of the present invention.

FIG. 3 is a view schematically illustrating a window displayed on a monitor illustrated in FIG. 1, in which an example of a medical document is displayed.

FIG. 4 is a view schematically illustrating a window displayed on the monitor illustrated in FIG. 1, in which examples of medical images are displayed.

FIG. 5 illustrates modified examples of medical images observed in association with user's operations, according to the first exemplary embodiment of the present invention.

FIG. 6 is a view schematically illustrating an example of a graphic user interface (GUI) display, in which the direction of a displayed medical image is changed, according to the first exemplary embodiment of the present invention.

FIG. 7 is a view schematically illustrating an example of a medical document accompanied with a schema background image, which is displayed in the window of the monitor illustrated in FIG. 1.

FIG. 8 is a flowchart illustrating an example of a processing procedure of a method for controlling the diagnostic supporting apparatus according to a second exemplary embodiment of the present invention.

FIG. 9 is a view schematically illustrating an example of medical images to be displayed as schema background image candidates according to the second exemplary embodiment of the present invention.

### DESCRIPTION OF THE EMBODIMENTS

The accompanying drawings, which are incorporated in and constitute a part of the specification, illustrate exemplary embodiments, features, and aspects of the invention and, together with the description, serve to explain the principles of the invention. The following exemplary embodiments are mere examples. The present invention is not limited to the following illustrated configurations of the exemplary embodiments.

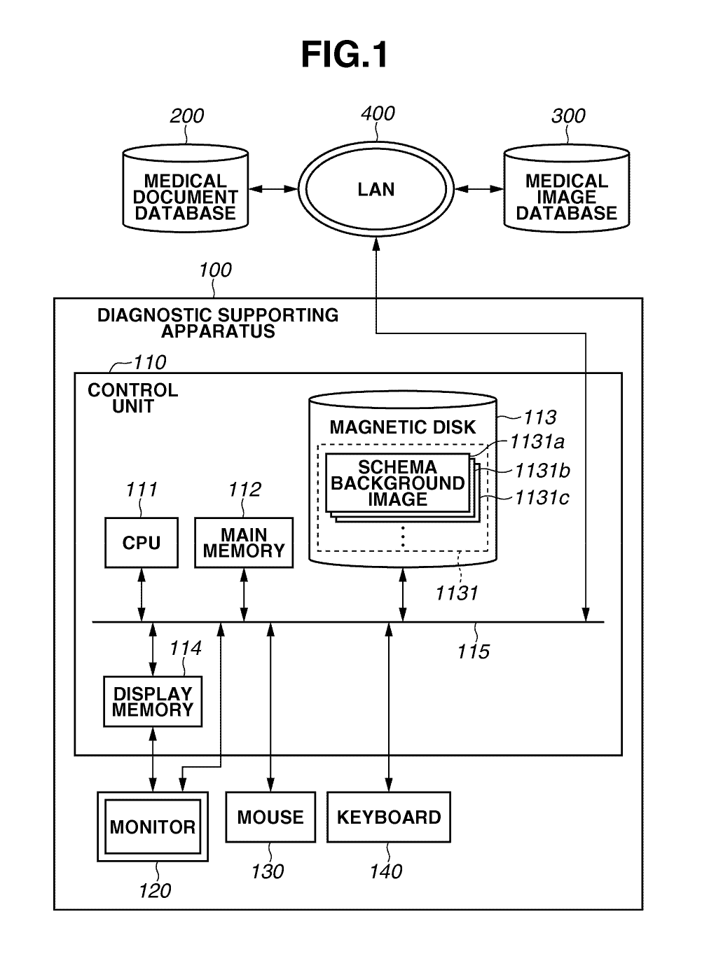

First, a first exemplary embodiment of the present invention is described. FIG. 1 is a view schematically illustrating an example of an overall configuration of a diagnostic support system according to the first exemplary embodiment of the present invention.

As illustrated in FIG. 1, the diagnostic support system according to the present exemplary embodiment includes a diagnostic supporting apparatus 100, a medical document database 200, a medical image database 300, and a local area network (LAN) 400. According to the configuration of the diagnostic support system illustrated in FIG. 1, the diagnostic supporting apparatus 100 is connected, via the LAN 400, to the medical document database 200 and the medical image database 300.

The diagnostic supporting apparatus 100 is an apparatus that can support physicians who perform diagnoses using schema background images. The diagnostic supporting apparatus 100 includes a control unit 110, a monitor 120, a mouse 130, and a keyboard 140.

The control unit 110 can control various operations to be performed by the diagnostic supporting apparatus 100. The control unit 110 includes a central processing unit (CPU) 111, a main memory 112, a magnetic disk 113, a display memory 114, and a bus 115. The CPU 111 can execute software programs stored in the main memory 112, for example, to communicate with the medical document database 200 and the medical image database 300 and to control various operations to be performed by the diagnostic supporting apparatus 100.

The CPU 111 can control operations to be performed by respective constituent elements of the diagnostic supporting apparatus 100 and can integrally control the diagnostic supporting apparatus 100.

The main memory 112, for example, stores control programs to be executed by the CPU 111. The main memory 112 can provide a work area for the CPU 111 when the CPU 111 executes the programs.

The magnetic disk 113, for example, stores an operating system (OS), device drivers for peripheral devices, and various application software programs. The magnetic disk 113 further stores image data relating to a plurality of basic schema background images 1131. In the following description, the basic schema background images may be referred to as basic schema image data.

In the present exemplary embodiment, the basic schema image data 1131 can be prepared beforehand as model patterns, which are classified into a plurality of levels in preciseness, for example, for each region of the human body structure, and can be registered in association with each region. More specifically, the basic schema image data 1131a, 1131b, 1131c . . . are stored and registered in the magnetic disk 113.

The display memory 114 temporarily stores display data to be displayed on the monitor 120.

The constituent elements of the diagnostic supporting apparatus 100 are mutually connected via the bus 115 and can communicate with each other. The diagnostic supporting apparatus 100 can communicate, via the bus 115, with external devices accessible via the LAN 400.

The monitor 120 is, for example, a cathode ray tube (CRT) monitor or a liquid crystal monitor. The monitor 120 can display an image based on the display data stored in the display memory 114 according to a control signal supplied from the CPU 111.

The mouse 130 and the keyboard 140 enable users to perform pointing input and character input operations.

The diagnostic supporting apparatus 100 according to the exemplary embodiment can read medical document data (e.g., electronic clinical records and image diagnosis reports) from the medical document database 200 via the LAN 400. The diagnostic supporting apparatus 100 can further read various types of medical image data (i.e., medical inspection data) from the medical image database 300 via the LAN 400.

The diagnostic supporting apparatus 100 can be connected to an external storage device (e.g., a floppy disk drive (FDD), a hard disk drive (HDD), a compact disk (CD) drive, a digital versatile disk (DVD) drive, a magneto-optical (MO) drive, and a ZIP drive), and can read medical document data and/or medical image data from the external storage device. For example, the medical images include simple X-ray images (roentgen images), X-ray CT images, MRI images, PET images, SPECT images, and ultrasonic images.

The medical document database 200, for example, stores medical document data (e.g., electronic clinical records and image diagnosis reports) generated by the diagnostic supporting apparatus 100 as well as medical document data received from other apparatus connected via the LAN 400.

The medical image database 300, for example, stores medical image data transmitted from each modality connected via the LAN 400.

The LAN 400 connects the diagnostic supporting apparatus 100 to the medical document database 200 and the medical image database 300 so that the diagnostic supporting apparatus 100 can communicate with the medical document database 200 and the medical image database 300.

A processing procedure of a method for controlling the diagnostic supporting apparatus 100 according to the first exemplary embodiment is described below.

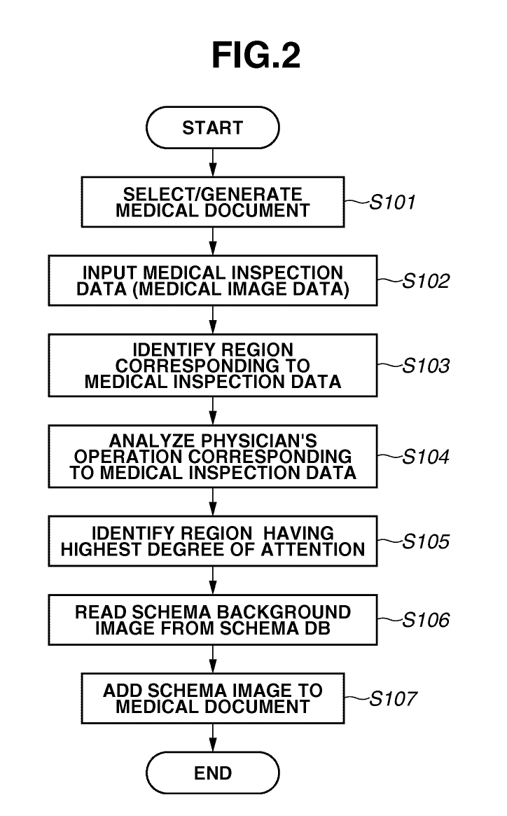

FIG. 2 is a flowchart illustrating an example of the processing procedure of the method for controlling the diagnostic supporting apparatus 100 according to the first exemplary embodiment of the present invention. More specifically, the CPU 111 executes the programs stored in the main memory 112 to realize the processing of the flowchart illustrated in FIG. 2.

Further, in the following processing, a physician (i.e., a user) operates the mouse 130 and the keyboard 140 to input various commands (e.g., instructions and commands) into the diagnostic supporting apparatus 100. Further, in the following processing, execution situations and results of the programs executed by the CPU 111 are momentarily displayed on the monitor 120. The physician gives necessary instructions while viewing the information displayed on the monitor 120.

First, in step S101 illustrated in FIG. 2, the CPU 111 reads (selects) one of the medical document data having been previously generated according to a command input by the physician and stores the read data in the main memory 112. Alternatively, the CPU 111 can generate new medical document data on the main memory 112. In this manner, the CPU 111 can acquire the medical document data.

Then, the CPU 111 generates display data to be stored in the display memory 114 based on the medical document data acquired in the main memory 112. The CPU 111 displays the generated display data in a window displayed on the monitor 120. Thus, a medical document based on the medical document data can be displayed on the monitor 120.

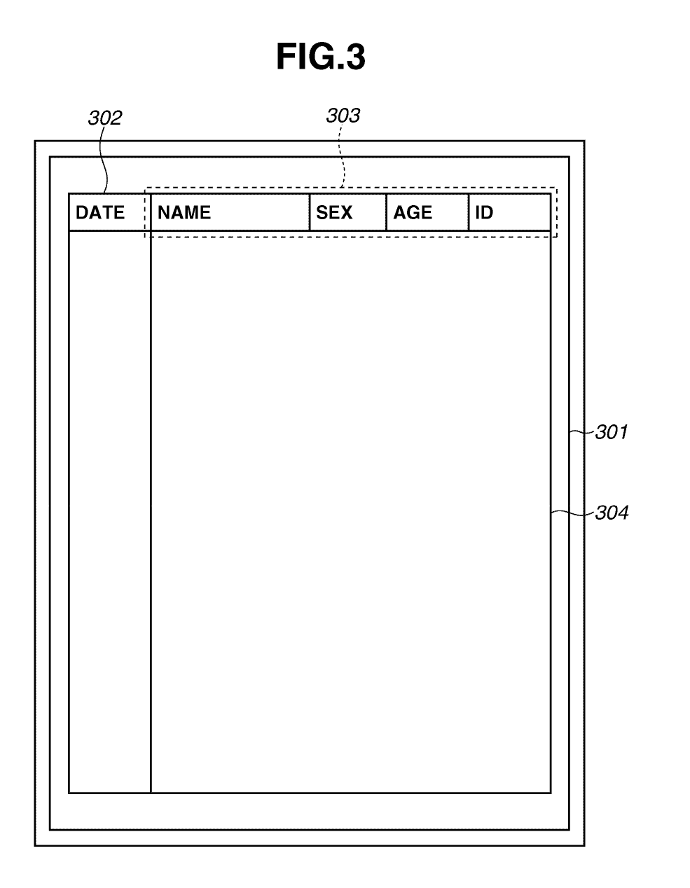

FIG. 3 is a view schematically illustrating a window 301 displayed on the monitor 120 illustrated in FIG. 1, in which an example of a medical document is displayed. The medical document illustrated in FIG. 3 does not include any information that is unnecessary to describe the present exemplary embodiment.

The window 301 illustrated in FIG. 3 includes a date field 302 which is positioned on the left side. The window 301 further includes a patient information field 303 and an observation description field 304. The patient information field 303 is positioned at an upper part of the window 301. The observation description field 304 is positioned beneath the patient information field 303, as a relatively large field in which physician's observations can be described. The format for the window 301 is not limited to the one illustrated in FIG. 3.

In the present exemplary embodiment, to realize the medical document data selection processing to be performed in step S101, the CPU 111 communicates with the medical document database 200 via the bus 115 and the LAN 400 and receives desired medical document data from the medical document database 200. Alternatively, the CPU 111 can read desired medical document data from an external storage device (not illustrated) connected to the diagnostic supporting apparatus 100. In this case, for example, the physician can input a patient ID to designate the medical document data to be selected. The CPU 111 receives the instructed medical document data from the medical document database 200 (or the external storage device) based on the physician's designation.

Next, in step S102, the CPU 111 inputs medical inspection data of an inspection object in the main memory 112 according to the command input entered by the physician. The CPU 111 generates display data to be stored in the display memory 114 based on the input medical inspection data. The CPU 111 causes the monitor 120 to display an image based on the generated display data.

In the present exemplary embodiment, the medical inspection data input in the main memory 112 is inspection object data relating to the basic schema background image (i.e., the basic schema image data 1131) stored beforehand in the magnetic disk 113. In this case, the CPU 111 displays an image (i.e., display data) derived from the medical inspection data in a window different from the window in which an image (i.e., display data) derived from the medical document data is displayed. In the present exemplary embodiment, the medical inspection data is, for example, medical image data.

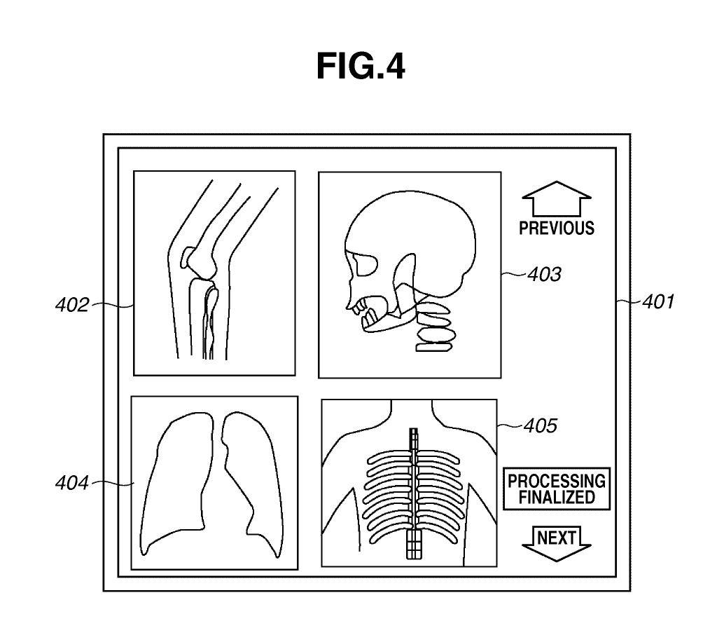

FIG. 4 is a view schematically illustrating a window 401 displayed on the monitor 120 illustrated in FIG. 1, in which examples of the medical images are displayed. As illustrated in FIG. 4, four pieces of X-ray images 402, 403, 404, and 405 are displayed, as medical images, in the window 401. The medical images according to the present exemplary embodiment are not limited to the medical images illustrated in FIG. 4. For example, the number of the medical images to be displayed in the window 401 can be changed. If the number of the medical images is increased, the images can be selectively displayed in the window 401 according to a conventional switching method.

In the present exemplary embodiment, to realize the medical inspection data (i.e., medical image data) input processing to be performed in step S102, the CPU 111 communicates with the medical image database 300 via the bus 115 and the LAN 400 and receives desired medical image data from the medical image database 300. Alternatively, the CPU 111 can read new medical image data from an external storage device connected to the diagnostic supporting apparatus 100. In the present exemplary embodiment, the CPU 111 can receive, from the medical image database 300 (or the external storage device), for example, a patient ID of a designated medical document and medical image data associated with an inspection number, which are stored in the main memory 112.

In the present exemplary embodiment, the medical inspection data (i.e., medical image data) read in step S102 can be recorded and supplied according to the DICOM standard. The medical image data reading processing can be executed according to a command input by the physician. Alternatively, when the medical document data is read in step S101, relevant medical image data can be automatically read in association with the read medical document data.

Next, in step S103 illustrated in FIG. 2, the CPU 111 identifies an internal body region of a photographed person, which is input in step S102 and displayed as a medical image, and also determines the position of the identified region in the medical image. In the present exemplary embodiment, the internal body region of the photographed person can be a region corresponding to each internal organ, such as “stomach”, “lung”, “liver”, and “heart”, or can be a more detailed region of each internal organ, such as “right lung” or “left ventricle.” Further, the internal body region of the photographed person can be a wider region, such as “chest” or “abdomen”, which includes two or more internal organs.

Accordingly, if a target image (i.e., a target medical image) input in step S103 is a right lung region, the input target image (i.e., the input target medical image) can be regarded as a part of the lung or can be regarded as a part of the chest. In other words, information indicating a specific region of a medical image identified in step S103 is not limited to only one. As described above, the information indicating the specific region identified in step S103 can be defined using a hierarchical expression including a plurality of regions, such as “upper half body-chest-lung-right lung.”

Further, in step S103, if the input medical image includes a plurality of human body regions, the CPU 111 identifies each region using a similar expression. For example, if the input medical image is a simple X-ray chest image, the CPU 111 can identify each one of the plurality of regions using a hierarchical expression, such as “upper half body-chest-lung-right lung” or “upper half body-chest-heart-ventricle-right ventricle” as described above.

It is generally known that a region position map indicating the position of each human body region in the image can be statistically generated based on data of numerous simple X-ray chest images. For example, the technique discussed in the U.S. Pat. No. 5,668,888. can be used to associate an X-ray image including a target chest image with a statistical region map, so that a target human body region can be accurately identified in the X-ray image.

The present exemplary embodiment is not limited to the above-described method. For example, as another method, if the input medical image is a three-dimensional CT image, the technique discussed in the non-patent literature by Sato, Shimizu can be used. According to Sato, Shimizu, “Construction of probabilistic atlas of abdominal organs and its application to segmentation of plural organs”, Medical Imaging Technology, Vol. 24, No. 3, pp. 153-160, May 2006, an object image is a three-dimensional X-ray CT image of an abdomen.

In this case, the abdomen includes various regions, such as right/left kidney, spleen, pancreas, liver, gallbladder, and stomach wall. A region spatial presence probability (i.e., probabilistic atlas) of each abdominal region can be used. The probabilistic atlas can be obtained by statistically analyzing the region shape, density value distribution, and spatial layout of numerous medical image data representing solid substances. Further, to define (register) a relationship with an object three-dimensional CT image, apexes of the right and left kidneys and the lowest point of the spleen can be used as indices (which can be referred to as “landmarks”), as is conventionally well known.

Further, as another method, DICOM header information attached to a medical image is usable. The DICOM header includes, in addition to patient information (e.g., age and sex), shooting information (e.g., shooting date and time, modality information, and shooting parameters) and shooting positional information (e.g., shooting object region, posture during shooting operation, and shooting position of human body). The information representing a positional relationship between a region and another region in an image can be obtained by using the shooting positional information. In this case, the positional information indicating a region to be expressed as an upper-layer element in a hierarchical structure needs not to be expressed accurately and therefore can be roughly expressed. For example, a statistical (i.e., probabilistic) position can be used.

Next, in step S104 illustrated in FIG. 2, the CPU 111 performs operation analysis processing for analyzing an operation performed by the physician (i.e., the user) on a medical image based on the medical image data displayed in step S102. More specifically, the CPU 111 estimates a degree of attention paid to each human body region by analyzing the information indicating the physician's (i.e., user's) operations performed on the medical image. Namely, the CPU 111 estimates how the physician has paid attention to each human body region in the medical image.

In the present exemplary embodiment, the physician (i.e., the user) performs the following operations on the medical image to improve the clearness of a target human body region in the medical image while observing the medical image displayed on the monitor 120.

The three-dimensional CT image is generally composed of a plurality of two-dimensional images. The physician performs an operation for observing a two-dimensional image that can clearly display a lesion, which is included in the three-dimensional CT image. To this end, the physician can scroll the medical image with the mouse 130. Further, a similar operation can be realized by using arrow keys of the keyboard 140, or inputting a numerical value indicating a slide number, or using a slide bar of the GUI.

Further, in the case of the three-dimensional CT image, the physician may perform an operation for observing a two-dimensional image captured from a direction perpendicular to the CT shooting direction in addition to a two-dimensional image captured from the CT shooting direction, for the purpose of observing an image that can clearly display the lesion.

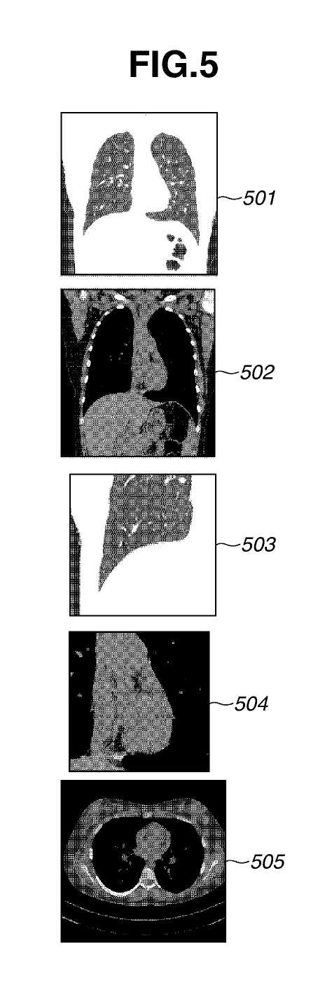

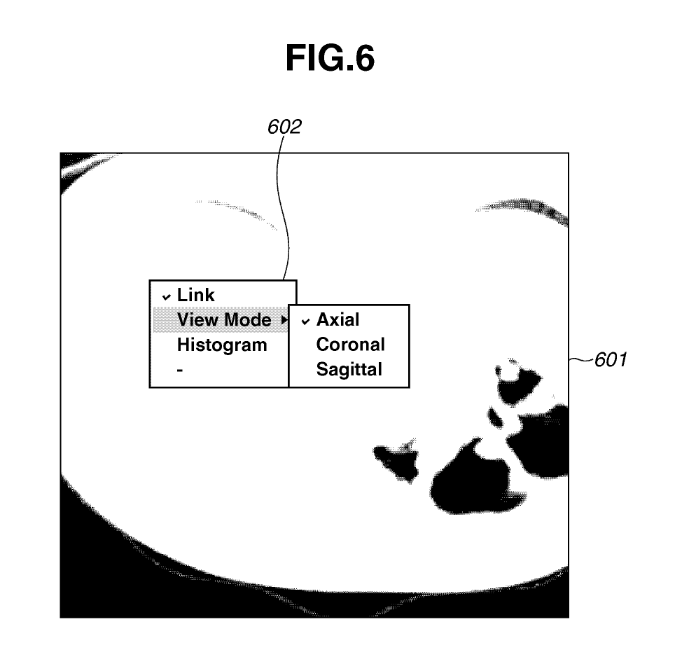

FIG. 5 illustrates modified examples of medical images observed in association with user's operations, according to the first exemplary embodiment of the present invention. Further, FIG. 6 is a view schematically illustrating an example of a GUI display, in which the direction of a displayed medical image is changed, according to the first exemplary embodiment of the present invention.

In FIG. 5, a medical image 505 is an image to be displayed according to an axial view mode and a medical image 502 is an image to be displayed according to a coronal view mode, which can be generated using the data of the same three-dimensional CT image. Further, although not illustrated in FIG. 5, an image according to a sagittal view mode and an image according to any other view mode can be also displayed. To perform the above-described operation, for example, as illustrated in FIG. 6, a sub menu 602 can be displayed on a displayed medical image 601 to enable users to select a desired view mode. Further, a preset button may be used to perform the above-described setting operation.

In the case of the three-dimensional CT image, the dynamic range is wide (−1024 to 512). It is generally difficult to clearly display all human body regions in a single image. Therefore, it may be useful that the physician performs an operation for appropriately adjusting display conditions (e.g., contrast of image) depending on each target human body region or each lesion. Two chest CT images (i.e., medical images) 501 and 502 illustrated in FIG. 5 are examples that are differentiated in their display conditions.

The medical image 501 is an image for which the CT value is set, for example, in a range from −1024 to −512, to clearly observe the lung (i.e., to prioritize the conditions for displaying a lung field). On the other hand, the medical image 502 is an image for which the CT value is set in a range from −512 to +512, to easily diagnose a mediastinum of the chest or a soft tissue of a chest wall or the heart (i.e., to prioritize the conditions for displaying the mediastinum or the like). The setting of display conditions according to the present exemplary embodiment can be performed with a preset button prepared beforehand. The keyboard 140 can be also used to change a display level or directly input a display width.

The physician (i.e., the user) can perform an operation for enlarging each target region if the clearness of the target region is insufficient. The enlargement operation performed in this case may be an operation for enlarging the target region entirely or an operation for enlarging the target region partly.

A medical image 503 illustrated in FIG. 5 is an image that partly enlarges the medical image 501, which can be obtained according to an operation of the physician (i.e., the user) who has paid attention to a lower portion of the right lung.

The above-described operations by the physician may not be constantly performed according to the above-described order. For example, the physician's operations may be performed according to a different order or may be repetitive to clearly display the target region. Further, the physician's operations may further include rotating medical images. The operations according to the present exemplary embodiment are not limited to the above-described operations. Hence, in the present exemplary embodiment, a human body region targeted by the physician can be estimated by analyzing the above-described operations.

The human body region targeted by the physician is present in a selected sliced image. Therefore, the CPU 111 estimates the human body region captured in the sliced image as having a higher degree of attention. Further, to greatly differentiate the degree of attention, it may be useful to determine the degree of attention with reference to the ratio of an area of each captured region. In this case, the CPU 111 can use the information relating to the human body region identified in step S103 to identify the region captured in the sliced image.

Similar to the selected sliced image, if a physician is observing a medical image captured in a different direction, the CPU 111 estimates that the human body region in the medical image captured in this direction has a higher degree of attention. In this case, similar to the above-described sliced image selection operation, it is useful to determine the degree of attention with reference to the ratio of an area of each captured region. Further, to identify the region captured in the medical image, the CPU 111 can use the information relating to the human body region identified in step S103.

To determine the order of the human body region identified in the sliced image selection operation, adjustment information for display conditions can be referred to in addition to region area information. To clearly observe a target region, physicians usually perform a contrast adjustment suitable for each target region. Therefore, if the display contrast of a region is high, the CPU 111 determines that this region has a higher degree of attention correspondingly.

It has been already described that the estimation of a target region can be realized by operating display conditions of a three-dimensional CT image. There is other modality, such as an MRI medical image, which has a wide dynamic range. The contrast adjustment can be similarly performed to estimate each human body region. In this case, however, a pixel value of the MRI medical image is not standardized. Therefore, the pixel value of the MRI medical image is not included in the uniform display conditions.

However, a human body region having a higher contrast can be easily detected by performing the contrast analysis on a displayed image itself. The CPU 111 can estimate that the human body region in the image has a higher degree of attention if the region has a higher contrast and is easily recognizable. When the physician performs an operation for enlarging an image, the CPU 111 can determine that a target region is included in an enlarged medical image and can estimate a degree of attention for the target region. For example, it can be presumed that the physician has paid attention to a lower portion of the right lung according to the medical image 503 illustrated in FIG. 5.

Therefore, the CPU 111 estimates that the lower portion of the right lung has a higher degree of attention. Further, for example, according to a medical image 504 illustrated in FIG. 5, which is a partly enlarged image of the medical image 502, the CPU 111 can estimate that the soft tissue targeted by the physician is the heart. In this case, the CPU 111 can use the information relating to the human body region identified in step S103 to identify the target region in the enlarged image.

Further, as described above, in a case where the relationship between a simple X-ray chest image and the statistical region map is determined beforehand, the position of each region in the image can be estimated. Therefore, the CPU 111 can identify an enlarged region by (for example, linearly) calculating the position of an enlarged image. If a central region of the simple X-ray chest image is enlarged, for example, the CPU 111 can estimate that the heart is targeted. Therefore, the CPU 111 can estimate that the region in the enlarged image has the highest degree of attention.

Further, it is for example useful to employ information indicating image observation time or information indicating a finally observed image to determine the degree of attention for each region. More specifically, it is general that physicians take a relatively long time to observe an internal body region if it contains a possible lesion. Therefore, if no operation is input during a predetermined period of time, the CPU 111 can determine that the displayed image has a higher degree of attention. Therefore, the CPU 111 can constantly measure the time elapsed after each operation. The CPU 111 can estimate the degree of attention based on the elapsed time measured after the last operation.

The above-described operation input and the operation analysis method to be used in step S104 are mere examples. The present invention is not limited to the above-described examples.

Now referring back to FIG. 2, after the processing of step S104 is completed, the processing proceeds to step S105. When the processing proceeds to step S105, the CPU 111 generates a list of the internal body regions in descending order of the degree of attention with reference to the human body regions identified in step S103 and the degree of attention paid to each region (i.e., the analysis result in step S104). Then, the CPU 111 identifies (selects) a human body region which is highest in the degree of attention.

In the above-described description, the CPU 111 determines the degree of attention for each human body region based on physician's operations that are independent from each other (see step S104). Alternatively, the CPU 111 can combine two or more operations to determine the degree of attention for each region. In this case, in the present exemplary embodiment, the CPU 111 can determine the ranking in the degree of attention among a plurality of operations, for example, in the order of “degree of attention according to image observation time”>“degree of attention according to enlargement or partial enlargement”>“degree of attention according to adjustment of display conditions”>“degree of attention according to slice selection”>“degree of attention according to display direction.”

However, the operation to be prioritized is variable depending on each physician. Therefore, in the present exemplary embodiment, the CPU 111 can determine the degree of attention for each region, for example, according to a reversed order or according to a combination of the degrees of attention in respective operations, not according to the above-described order.

Next, in step S106, the CPU 111 selects a basic schema background image relating to the human body region having a higher degree of attention identified (selected) in step S105, from a plurality of basic schema background images stored in the magnetic disk 113. Then, the CPU 111 reads the selected basic schema background image. More specifically, the CPU 111 selects basic schema image data of the basic schema background image relating to the human body region having a higher degree of attention identified in step S105 from the basic schema image data 1131 (i.e., image data of a plurality of basic schema background images stored in the magnetic disk 113).

In the present exemplary embodiment, as described above, the magnetic disk 113 stores a plurality of basic schema background images (i.e., the basic schema image data) so as to function as a schema background image storage device (i.e., a schema DB). Further, the magnetic disk 113 stores additional information (e.g., human organs contained in each schema background image, their regions and sizes, and the degree of detail of the structure represented by the schema background image) in association with the corresponding schema background image. Further, the recording and management for each schema background image can be performed according to the level expressed by each schema background image, for example, as discussed in the Japanese Patent Application Laid-Open No. 2006-318154.

Next, in step S107, the CPU 111 adds a basic schema image, which is based on the basic schema image data 1131 acquired in step S106, to the medical document (i.e., medical certificate) read in step S101. In this case, the CPU 111 can perform a display for the resultant image in a predetermined manner (e.g., superimposition or addition).

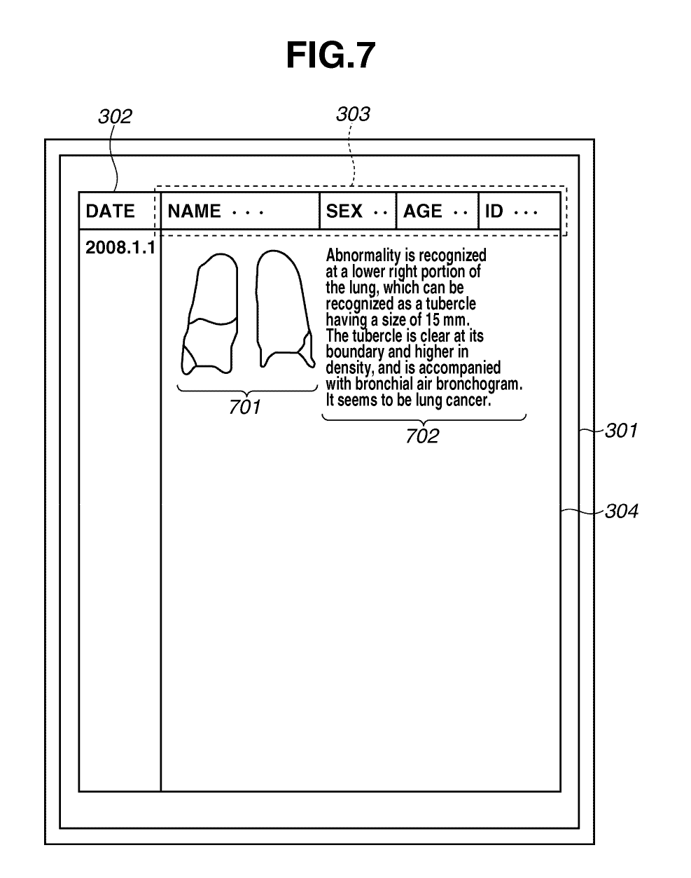

FIG. 7 is a view schematically illustrating an example of a medical document accompanied with a schema background image, which is displayed in the window 301 of the monitor 120 illustrated in FIG. 1. Compared to the medical document illustrated in FIG. 3, the medical document illustrated in FIG. 7 additionally includes a basic schema image 701 corresponding to the basic schema background image and related observation information 702 in the observation description field 304. Further, compared to the medical document illustrated in FIG. 3, the medical document illustrated in FIG. 7 includes date and time information added to the date field 302 and patient information added to the patient information field 303.

The physician performs an operation for inputting the observation information 702 referring to the basic schema image 701, which is relevant to the schema background image displayed in the window 301. Then, the CPU 111 registers the medical document data in the medical document database 200. Then, the CPU 111 terminates the processing of the flowchart illustrated in FIG. 2.

However, the basic schema background image used in the present exemplary embodiment is not limited to the one illustrated in FIG. 7. For example, the basic schema background image according to the present exemplary embodiment may be accompanied with relevant attribute information.

According to the above-described first exemplary embodiment, an operation of a user (e.g., a physician) performed to observe a medical image is analyzed and, when a medical document is generated, a suitable schema background image can be effectively selected from a plurality of schema background images.

A second exemplary embodiment of the present invention is described below. In the above-described first exemplary embodiment, the CPU 111 selects an appropriate schema background image according to the analysis on a physician's operation performed on a medical image. However, in a case where a medical image includes a plurality of human body regions, there may be two or more regions that are similar to each other in the degree of attention. It may be also difficult to identify a human body region having a higher degree of attention.

Hence, the second exemplary embodiment can display candidates of the basic schema background images (i.e., basic schema image data) to be displayed to allow physicians to select an appropriate schema background image. The second exemplary embodiment can display an image of a medical document including a schema background image selected from the plurality of candidates.

An internal configuration of a diagnostic supporting apparatus according to the second exemplary embodiment is similar to the above-described internal configuration of the diagnostic supporting apparatus 100 according to the first exemplary embodiment illustrated in FIG. 1.

A processing procedure of a method for controlling the diagnostic supporting apparatus 100 according to the second exemplary embodiment is described below.

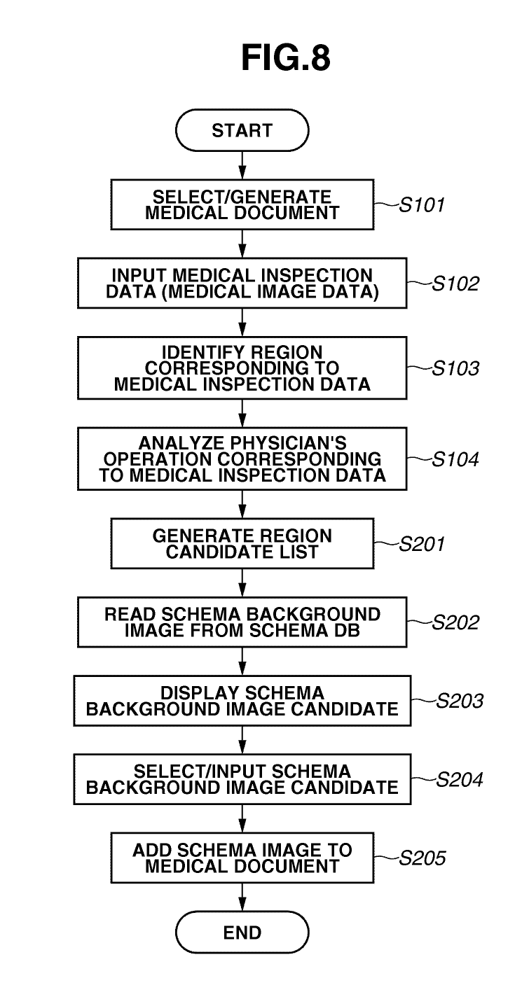

FIG. 8 is a flowchart illustrating an example of the processing procedure of the method for controlling the diagnostic supporting apparatus 100 according to the second exemplary embodiment of the present invention. In the present exemplary embodiment, processing similar to the above-described processing of the flowchart illustrated in FIG. 2 is denoted with the same step numbers and detailed descriptions for these steps are not repeated.

First, in the present exemplary embodiment, the CPU 111 executes the processing of the above-described steps S101 to S104 illustrated in FIG. 2.

Next, in step S201, the CPU 111 generates a region candidate list based on the human body regions identified in step S103, according to the analysis result of the operation analysis processing performed in step S104. In the present exemplary embodiment, the CPU 111 generates a priority list of the human body regions in descending order of the degree of attention with reference to a list of the regions estimated in step S104 and the degree of attention allocated to each region.

Then, the CPU 111 determines the order of the region candidates in the list with reference to the priority list. In this case, instead of referring to the degree of attention, it is also useful to refer to the size of each region or the ratio of each displayed region. Then, the CPU 111 generates a list of schema background image candidates (i.e., candidates of the basic schema background images) corresponding to the regions, with reference to the generated region candidate list.

Next, in step S202, the CPU 111 reads basic schema background images of the human body regions included in the region candidate list generated in step S201, from the plurality of basic schema background images stored in the magnetic disk 113 (i.e., the basic schema image data 1131). In the present exemplary embodiment, the CPU 111 processes each read basic schema background image (i.e., the basic schema image data 1131) as a basic schema background image candidate to be displayed (presented).

Next, in step S203, the CPU 111 causes the monitor 120 to display another window for the basic schema background image candidates (i.e., the basic schema image data 1131) to be displayed, which are read in step S202, so that physicians can select a suitable basic schema background image from the displayed candidates. In this case, the CPU 111 controls the monitor 120 to display the basic schema background image candidates according to the order of the region candidate list determined in step S201. This is effective because the display of a specific basic schema background image, in a case where it is requested by a physician, can be prioritized.

For example, in a state where a physician is observing a three-dimensional chest CT image with lung field display conditions, if the right lung is enlarged, the CPU 111 can prioritize the display of a basic schema background image corresponding to the right lung. If the bronchia and the entire lung are displayed in the same medical image, the CPU 111 continuously displays them as schema background image candidates. Further, according to the lung field display conditions, the priority order of a basic schema background image of the heart, which is generally difficult for physicians to observe, is low. Further, the priority order of each basic schema background image candidate can be changed considering the display direction of a medical image observed by physicians, even if the region is the same.

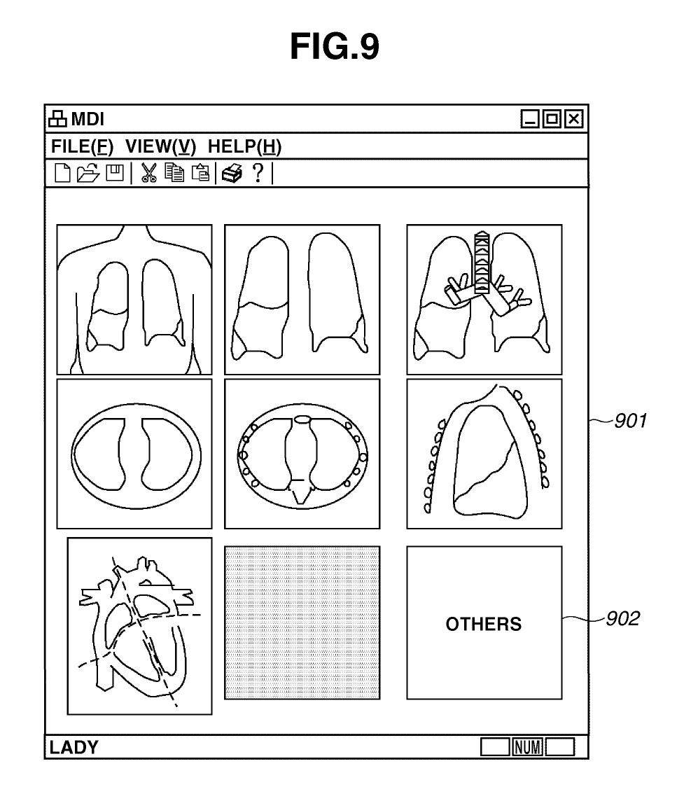

FIG. 9 is a view schematically illustrating an example of medical images to be displayed as schema background image candidates according to the second exemplary embodiment of the present invention. A plurality of images in a window 901 illustrated in FIG. 9 are basic schema background image candidates. If a physician cannot find a suitable basic schema background image in the displayed schema background image candidates, the physician can press an “others” button 902 to request a display of another images representing schema background images of different human body regions. In response to this requirement, the CPU 111 displays the images of the next schema background image candidates in the window 901.

Next, in step S204, the CPU 111 receives a selection result (i.e., an input indicating a basic schema background image to be displayed) from the physician. The CPU 111 selects the basic schema background image to be displayed, based on the selection input, from the plurality of basic schema background image candidates displayed in step S203. In this case, for example, the physician can select and input a desired basic schema background image with the mouse 130 from the images of the basic schema background image candidates displayed on the monitor 120. In the present exemplary embodiment, for example, an identification number can be allocated to each of the schema background image candidates. In this case, the physician can select and input the identification number of a schema background image to be displayed via the keyboard 140.

Next, in step S205, the CPU 111 adds a basic schema image, which is based on the basic schema background image (the basic schema image data 1131) acquired in step S204, to the medical document read in step S101. In this case, the CPU 111 can perform a superimposition display or a summation display. The display that can be realized by the CPU 111 is, for example, illustrated in FIG. 7 as described in the first exemplary embodiment.

Then, the physician performs an operation for inputting the observation information 702 referring to the basic schema image 701, which is relevant to the schema background image displayed in the window 301 illustrated in FIG. 7. Then, the CPU 111 registers the medical document data to the medical document database 200. Then, the CPU 111 terminates the processing of the flowchart illustrated in FIG. 8.

The basic schema background image used in the present exemplary embodiment is not limited to the one illustrated in FIG. 7. For example, the basic schema background image according to the present exemplary embodiment may be accompanied with relevant attribute information.

The second exemplary embodiment analyzes an operation of the user (e.g., the physician) performed to observe a medical image, estimates a schema background image candidate that the user (e.g., the physician) may want, and displays the estimated schema background image candidate. Therefore, the second exemplary embodiment can effectively select a suitable schema background image from a plurality of schema background images when a medical document is generated.

To realize respective steps (respective functional units) of the method for controlling the diagnostic supporting apparatus 100 according to the above-described exemplary embodiments of the present invention (see FIGS. 2 and 8), the CPU (111) of the computer can execute the program stored in a storage medium (e.g., the main memory 112). The present invention encompasses the above-described programs and the computer-readable storage medium that stores the programs.

Further, the present invention can be embodied, for example, as a system, an apparatus, a method, a program or a storage medium. More specifically, the present invention is applicable to a system including a plurality of devices. Further, the present invention is applicable to an apparatus including only one device.

The present invention encompasses software programs (i.e., programs corresponding to the flowcharts illustrated in FIGS. 2 and 8 in the above-described exemplary embodiments) that can realize the functions of the above-described exemplary embodiments. The software programs according to the present invention can be directly or remotely supplied to a system or an apparatus. The present invention further encompasses a computer of the system or the apparatus when the computer can read and execute the supplied program code.

Accordingly, the present invention encompasses the program code itself installable on a computer when the functions or processes of the exemplary embodiments can be realized by the computer. Namely, the present invention encompasses the computer program itself that can realize the functions and processes of the exemplary embodiments.

In this case, the programs can be replaced with any one of object codes, interpreter programs, and OS script data, if their functions are comparable with the programs.

A storage medium supplying the programs can be selected from any one of a floppy disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the programs includes accessing a web site on the Internet using the browsing function of a client computer, when the web site allows each user to download the computer programs relating to the present invention, or compressed files of the programs having automatic installing functions, to a hard disk or other recording medium of the user.

Furthermore, the program code constituting the programs relating to the present invention can be divided into a plurality of files so that respective files are downloadable from different web sites. Namely, the present invention encompasses World Wide Web (WWW) servers that allow numerous users to download the program files so that the functions and processes of the present invention can be realized on their computers.

Enciphering the programs relating to the present invention and storing the enciphered programs on a CD-ROM or comparable recording medium is an exemplary method when the programs relating to the present invention are distributed to the users. The authorized users (i.e., users satisfying predetermined conditions) are allowed to download key information from a web site on the Internet. The users can decipher the programs with the obtained key information and can install the programs on their computers.

When the computer reads and executes the installed programs, the functions of the above-described exemplary embodiments can be realized. Moreover, an operating system (OS) or other application software running on a computer can execute part or all of actual processing based on instructions of the programs, to realize the functions of the above-described exemplary embodiments.

Additionally, the programs read out of a storage medium can be written into a memory of a function expansion board inserted in a computer or into a memory of a function expansion unit connected to the computer. In this case, based on instructions of the program, a CPU provided on the function expansion board or the function expansion unit can execute part or all of the actual processing so that the functions of the above-described exemplary embodiments can be realized.

The above-described exemplary embodiments are mere examples that can embody the present invention. Therefore, it is to be understood that the scope of the present invention cannot be narrowly interpreted. The present invention can be embodied in various ways without departing from the technical concept thereof or essential features thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-015768 filed Jan. 27, 2009, the entire contents of which are hereby incorporated by reference herein.

What is claimed is:

1. A diagnostic supporting apparatus, comprising:
a storage unit configured to store a plurality of schema background;
an input unit configured to input medical inspection data of an inspection object;
an analysis unit configured to analyze an operation performed on the medical inspection data; and
a selection unit configured to select at least one schema background image, from the plurality of schema background images stored in the storage unit based on an analysis result obtained by the analysis unit.

2. The diagnostic supporting apparatus according to claim 1, further comprising:
an acquisition unit configured to acquire medical document data; and
a display unit configured to display a composite image including the medical document data and the at least one schema background image selected by the selection unit.

3. The diagnostic supporting apparatus according to claim 1, wherein the selection unit is configured to select one schema background image, from the plurality of schema background images stored in the storage unit, based on the analysis result obtained by the analysis unit.

4. The diagnostic supporting apparatus according to claim 1, wherein the selection unit is configured to generate a list of schema background image candidates to be displayed based on the analysis result obtained by the analysis unit, and is configured to select the schema background image from the list.

5. The diagnostic supporting apparatus according to claim 1, wherein the medical inspection data is a medical image.

6. The diagnostic supporting apparatus according to claim 5, wherein the analysis unit is configured to analyze at least one of an operation for adjusting conditions for displaying the medical image, an operation for magnifying the medical image, and an operation for adjusting an orientation of the medical image to be displayed.

7. The diagnostic supporting apparatus according to claim 4, wherein the selection unit is configured to generate the list of the schema background image candidates according to a degree of attention paid to a target region of the medical inspection data.

8. A method for performing diagnostic support by controlling a diagnostic supporting apparatus that is operatively connected to a central processing unit (CPU) and includes a storage unit, the method comprising:
storing a plurality of schema background images in the storage unit;
inputting, into the diagnostic supporting apparatus, medical inspection data of an inspection object;
analyzing, using the CPU, an operation performed on the medical inspection data; and
selecting at least one schema background image from the plurality of schema background images stored in the storage unit, based on an analysis result obtained by the analyzing step.

9. A computer-readable storage medium storing thereon a program that enables a computer to control operations of a diagnostic supporting apparatus that includes a storage unit configured to store a plurality of schema background images and can support a diagnosis to be performed based on at least one of the schema background images, the program comprising:
computer-executable instructions for inputting medical inspection data of an inspection object;
computer-executable instructions for analyzing an operation performed on the medical inspection data; and
computer-executable instructions for selecting a schema background image, from the plurality of schema background images stored in the storage unit, based on an obtained analysis result.

10. The computer-readable storage medium as defined in claim 9, wherein the operation performed on the medical inspection data includes at least one of an operation for adjusting conditions for displaying the medical image, an operation for magnifying the medical image, and an operation for adjusting an orientation of the medical image to be displayed.
